(19) United States
(12) Patent Application Publication
(10) Pub. No.: US 2024/0290936 A1
(43) Pub. Date: Aug. 29, 2024

(54) INTERMITTENT DIRECT DEPOSITION PROCESS FOR MANUFACTURING A COMPONENT OF A MEMBRANE ELECTRODE ASSEMBLY

(71) Applicants: W. L. Gore & Associates GmbH, Putzbrunn (DE); W. L. Gore & Associates G.K., Tokyo (JP)

(72) Inventors: Amr Mahmoud Hamdy Kobaisy Ali, Putzbrunn (DE); Masaki Tani, Tokyo (JP)

(21) Appl. No.: 18/541,647

(22) Filed: Dec. 15, 2023

Related U.S. Application Data
(60) Provisional application No. 63/387,507, filed on Dec. 15, 2022.

(51) Int. Cl. H01M 4/04; B05D 1/26

(52) U.S. Cl. CPC H01M 4/0407; B05D 1/265

(57) ABSTRACT

The present invention discloses a method of making a fuel cell component, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(iv) wherein the slot die is moveable between a non-coating position in which the slot die is in a first pre-determined distance relative to the substrate; and a coating position in which the slot die is in a second pre-determined distance relative to the substrate; and wherein the forming step further comprises
(v) configuring the slot die for predetermined intermittent delivery of coating composition to produce an electrode on the substrate when the slot die is in the coating position.

### CROSS-REFERENCE TO RELATED APPLICATION

This application claims the benefit of Provisional Application No. 63/387,507, filed Dec. 15, 2022, which is incorporated herein by reference in its entirety for all purposes.

### FIELD OF THE INVENTION

The present disclosure relates to membrane electrode assemblies for polymer electrolyte membrane (PEM) fuel cells, and in particular, to a method of making a component of a membrane electrode assembly (MEA) using an intermittent direct deposition process.

### BACKGROUND OF THE INVENTION

A membrane electrode assembly (MEA) is a core component of a polymer electrolyte membrane (PEM) Fuel Cell. A membrane electrode assembly (MEA) is comprised of a polymer electrolyte membrane (PEM) with an anode electrode on one side of the PEM and a cathode electrode on the other side of the PEM. Thus, the final MEA may comprise a three-layer assembly, including an anode layer, a PEM layer and a cathode layer. Additionally, the MEA may also include Gas Diffusion Layers (GDLs), which are typically comprised of carbon paper, and are attached to the outer surface of each electrode. If GDLs are attached to both electrodes then the final MEA is considered a five-layer assembly including a first layer of GDL, an anode layer, a PEM layer, a cathode layer and another layer of GDL. Typically, the PEM and GDLs have sufficient mechanical integrity to be self-supporting webs, but the electrodes do not have the sufficient mechanical integrity. Therefore, each electrode is typically formed on a substrate which may be the PEM, a GDL, or a release layer. The layers of the MEA are then bonded together with heat and/or pressure as needed to form a composite sheet.

There are various established techniques for forming the electrodes on a substrate and/or bonding the electrodes to other layers of the MEA; however, each technique has problems. Traditionally, the electrodes were coated onto a release layer and then laminated to a PEM. However, this method is inefficient, costly, and wasteful. More recently, this process has been streamlined by coating the electrodes directly onto the PEM. Direct coating can enable low cost and high-volume production. Techniques for direct coating include slot die, screen printing or spray coating. The direct coating can be applied on a substrate continuously or discontinuously (intermittent). An intermittent depositing process is used to produce a pattern of discontinuous electrodes being provided on the substrate. Intermittent coating saves waste on expensive electrode ink material and is therefore preferred to large scale production but can be challenging due to edge deterioration of the electrode pieces. In particular, the intermittent depositing processes give rise to defects with poor edge quality being produced at the electrode leading and trailing edges formed from the deposited coating composition. Such poor quality of the edges of the deposited electrodes can lead to reduction of the lifetime of the MEA and is shown schematically in FIG. 6B [prior art] of the attached Figures.

Accordingly, the need exists for improved methods of manufacturing components for membrane electrode assemblies in an efficient and cost-effective manner, using intermittent direct deposition methods. In particular, there is a need for a defect free, good edge quality and high-speed intermittent coating method.

### SUMMARY OF THE INVENTION

In one embodiment, the present disclosure relates to a method of making a fuel cell component, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; wherein the forming further comprises
(vi) configuring the slot die for predetermined intermittent delivery of coating composition to produce an electrode on the substrate when the slot die is in the coating position.

In one embodiment, the first and the second pre-determined distance relative to the substrate is provided by a vertical movement of the slot die. In another embodiment, the movement of the slot die between the non-coating position and coating position is a vertical movement in relation to the substrate.

In one embodiment the substrate is arranged horizontally in relation to the vertical movement of the slot die. The substrate may be moved horizontally relative to the slot die.

In another embodiment, the vertical movement of the slot die may be combined with a horizontal movement of the slot die relative to the surface of a non-moving substrate.

In one embodiment, the method comprises the step of providing a pump in fluid communication with the slot die for controlled intermittent delivery of coating composition from the slot die to the substrate, the pump being adapted to be turned off by putting the pump into an OFF condition and the pump being adapted to be turned on by putting the pump into an ON condition.

In another embodiment, the method further comprises moving the slot die between the non-coating position and the coating position in a controlled, pre-determined manner to deliver coating composition to the substrate in a pre-determined pattern of delivery, wherein in the non-coating position, the slot die is located at a first pre-determined distance relative to the substrate; and

in the coating position, the slot die is located at a second pre-determined distance relative to the substrate; wherein
in the first pre-determined distance, the slot die is located further away from the substrate than in the second pre-determined distance.

In another embodiment, the first pre-determined distance defines a Hup position of the slot die and the second pre-determined distance defines a Hdown position of the slot die.

In another embodiment, the pump is changed from the OFF condition to the ON condition, before or after the slot die is moved from the non-coating position to the coating position.

In another embodiment, the pump is changed from the ON condition to the OFF condition, before or at the same time as the slot die is moved from the coating position to the non-coating position.

In another embodiment, the pump is changed from the OFF condition to the ON condition after the slot die is moved from the non-coating position to the coating position, wherein the distance (delta L1) the substrate moves in the horizontal direction when the slot die is in the coating position with the pump in the OFF condition, is up to 50% of the distance (L1) the substrate moves in the horizontal direction when the slot die is in the coating position.

In another embodiment, the pump is changed from the OFF condition to the ON condition before the slot die is moved from the non-coating position to the coating position, wherein the distance (delta L1) the substrate moves in the horizontal direction when the slot die is in the non-coating position with the pump in the ON condition, is up to 50% of the distance (L1) the substrate moves in the horizontal direction when the slot die is in the coating position.

In another embodiment, the pump is changed from the ON condition to the OFF condition before the slot die is moved from the coating position to the non-coating position, wherein the distance (delta L2) the substrate moves in the horizontal direction when the slot die is in the coating position with the pump in the OFF condition, is up to 50% of the distance the substrate moves in the horizontal direction when the slot die is in the coating position (L1).

In another embodiment, the method comprises the step of providing a controller programmed with pre-determined parameters for controlling the intermittent delivery of the coating composition from the slot die to the substrate.

In another embodiment, the method comprises the step of controlling the intermittent delivery of the coating composition from the slot die using pre-determined vertical movement of the slot die and the turning the pump to the OFF and ON conditions.

In another embodiment, the substrate comprises a polymer electrolyte membrane (PEM).

In another embodiment, the fuel cell component is a membrane electrode assembly (MEA).

In another embodiment, the fuel cell component is a catalyst coated membrane (CCM). The catalyst coated membrane may comprise a one side catalyst coating or a two-side catalyst coating.

In another embodiment, the coating composition comprises a catalyst and an ionomer.

In one embodiment, the catalyst comprises a noble metal, a transition metal, or an alloy thereof.

In another embodiment, the ionomer is a proton-conducting polymer.

In another embodiment, the proton-conducting polymer comprises perfluorosulfonic acid.

In another embodiment, the electrode may be a cathode or anode. In one embodiment, the electrode on the first side of the substrate forms a cathode; and the electrode on the second side of the substrate forms an anode.

In another embodiment, the coating composition is deposited on to the substrate intermittently, to form first and second electrodes on the first and second sides of the substrate, respectively.

In one embodiment, the coating composition comprising a solution comprising at least 5% wt solids for forming the cathode.

In one embodiment, the coating composition comprising a solution comprising at least 5% wt solids for forming the anode.

In one embodiment, a gap to thickness ratio is used to determine the coating position of the slot die wherein the thickness is defined as the thickness of the deposited coating composition. The coating position of the slot die may be characterized by the second pre-determined distance. In embodiments the second pre-determined distance is the gap between the head of the slot die and the surface of the substrate when the head of the slot die is closest to the surface of the substrate.

In another aspect, the present disclosure relates to a method of making a fuel cell component, the method comprising:
forming an electrode on a polymer electrolyte membrane (PEM), wherein the forming comprises the following steps:
(i) providing a PEM substrate;
(ii) providing an electrode coating composition;
(iii) providing apparatus comprising a slot die configured for intermittent delivery of the electrode coating composition to the PEM substrate;
(iv) wherein the forming includes intermittently depositing the coating composition on the PEM substrate;
(v) wherein the slot die is moveable between a non-coating position in which the slot die is in a first pre-determined distance relative to the PEM substrate; and a coating position in which the slot die is in a second pre-determined distance relative to the PEM substrate; wherein the forming further comprises
(vi) configuring the slot die for intermittent delivery of electrode coating composition to produce an electrode on the PEM substrate, wherein the slot die is in the coating position.

The method of this disclosure describes an intermittent direct coating process of catalyst ink material (coating composition) on the surface of a polymer electrolyte membrane using a slot die coater. The slot die coater provides the intermittent delivery of the coating composition (catalyst ink) forming an intermittent electrode pattern according to pre-determined parameters for controlling the intermittent delivery.

In one embodiment, the method comprises the use of a pump in fluid communication with the slot die for a controlled intermittent delivery of coating composition (catalyst ink material) from the slot die to the substrate. The method of this disclosure controls the flow of the pump and the vertical movement of the slot die over the substrate so as to break the fluid flow cleanly. The coordination and control of the pre-determined parameters of the slot die and the pump provides a clean intermittent delivery of the coating composition to form a defect free intermittent electrode pattern with good edge quality.

The intermittent direct coating method according to this disclosure can be used on one side of the substrate or on both sides of the substrate. In another embodiment the intermittent direct coating method according to this disclosure is used on one side of the substrate while the other side of the substrate is provided with a continuous coating.

In another embodiment, the disclosure relates to a method of making a fuel cell component, the method comprising forming a first electrode on a polymer electrolyte membrane, wherein the forming comprises depositing a coating composition on a first side of the polymer electrolyte membrane for forming a first electrode thereon using the above intermittent process, making a second side of the polymer electrolyte membrane available for forming an electrode thereon; and forming a second electrode on the second side of the polymer electrolyte membrane using the above intermittent process.

In one embodiment, the present disclosure relates to a method of making a component of a water electrolysis device, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; wherein the forming further comprises
(vi) configuring the slot die for predetermined intermittent delivery of coating composition to produce an electrode on the substrate when the slot die is in the coating position.

In some embodiments, the substrate comprises a polymer electrolyte membrane (PEM).

In certain embodiments, the component of the water electrolysis device is a membrane electrode assembly (MEA).

In another embodiment, the component of the water electrolysis device is a catalyst coated membrane (CCM). The catalyst coated membrane may comprise a one side catalyst coating or a two-side catalyst coating.

### BRIEF DESCRIPTION OF THE DRAWINGS:

The present invention will be better understood in view of the following non-limiting figures, in which:

FIG. 1A shows a schematic diagram of a direct coating process;

FIG. 1B shows a cross section along line AA, from FIG. 1A;

FIG. 2 shows an example of an apparatus for direct coating on a PEM using a slot die;

FIG. 3 shows a process diagram of a method according to the disclosure;

FIGS. 4A to 4C show several process diagrams of a method according to the disclosure;

FIGS. 5A to 5E show several embodiments of a fuel cell component or component of a water electrolysis device made with the a method according to the disclosure; and

FIG. 6A shows an example of an ink deposit with a high quality trailing edge which can be achieved using the process of the present disclosure; and

FIG. 6B [prior art] shows an example of an ink deposit with a poor quality trailing edge as tends to occur using the prior art processes.

### DETAILED DESCRIPTION OF THE INVENTION

Persons skilled in the art will readily appreciate that various aspects of the present disclosure can be realized by any number of methods and apparatus configured to perform the intended functions. It should also be noted that the accompanying figures referred to herein are not necessarily drawn to scale, and may be exaggerated to illustrate various aspects of the present disclosure, and in that regard, the figures should not be construed as limiting. Directional references such as “up,” “down,” “top,” “left,” “right,” “front,” and “back,” among others are intended to refer to the orientation as illustrated and described in the figure (or figures) to which the components and directions are referencing. It is to be noted that all ranges described herein are exemplary in nature and include any and all values in between. In addition, all references cited herein are incorporated by reference in their entireties.

A membrane electrode assembly (MEA) is comprised of a polymer electrolyte membrane (PEM) with an anode electrode on one side and a cathode electrode on the other side. The final MEA may be a three-layer assembly, having the layers placed adjacent to each other as Anode-PEM-Cathode in the final MEA. Additionally, the MEA may also include Gas Diffusion Layers (GDLs) attached to the outer surface of each electrode. If GDLs are attached to both electrodes then the final MEA is considered a five-layer assembly, having the layers placed adjacent to each other as GDL-Anode-PEM-Cathode-GDL in the final MEA. According to various embodiments, the layers may be formed in any order, for example the PEM may be formed before the GDLs, the anode, or the cathode.

The invention seeks to improve defects with known direct coating methods. In particular, the invention provides a technical solution to the problem of edge quality deterioration for slot die printing, in particular intermittent slot die printing. The invention solves this problem by effectively controlling the pump flow and the slot die position. This results in a defect free, high speed intermittent coating, which has good edge quality. It is therefore possible to get good edge quality on high-speed intermittent coatings using the slot die coating process of this disclosure.

A method of intermittently coating of a coating composition like a catalyst ink on a substrate like a polymer electrolyte membrane (PEM) using a slot die coater will be described herein. In general, slot die coating is a known coating technique for the application of liquid coating compositions on flat substrates. The desired coating material is typically dissolved or suspended into a precursor solution or slurry (also referred as “ink”) and delivered onto the surface of the substrate through a precise coating head known as injection nozzle or a slot-die.

In one embodiment, the present disclosure relates to a method of making a fuel cell component, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; and wherein the forming further comprises
(vi) configuring the slot die for predetermined intermittent delivery of coating composition to produce an electrode on the substrate, when the slot die is in the coating position.

In another embodiment, the present disclosure relates to a method of making a component of a water electrolysis device, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; and wherein the forming further comprises
(vi) configuring the slot die for predetermined intermittent delivery of coating composition to produce an electrode on the substrate, when the slot die is in the coating position.

In another embodiment, the method comprises the step of providing a pump in fluid communication with the slot die for controlled intermittent delivery of coating composition from the slot die to the substrate, the pump being adapted to be turned off by putting the pump into an OFF condition and the pump being adapted to be turned on by putting the pump into an ON condition.

As used herein, the term “substrate” refers to a porous layer, a non-porous layer, or combinations thereof. In some embodiments, the substrate may comprise a gas diffusion layer or a release layer, like a backing layer.

In one embodiment, the substrate comprises a polymer electrolyte membrane (PEM), which may comprise a proton-conducting polymer or ion exchange material. The polymer electrolyte membrane may comprise at least one porous layer comprising a microporous polymer structure and an ion exchange material at least partially embedded within the microporous polymer structure and rendering the microporous polymer structure occlusive.

In some embodiments, the ion exchange material may be fully embedded within the microporous polymer structure. The ion exchange material may include more than one ion exchange material in the form of a mixture of ion exchange materials.

In other embodiments, the ion exchange material may include more than one layer of ion exchange material. The layers of ion exchange material may be formed of the same ion exchange material. Alternatively, the layers of ion exchange material may be formed of different ion exchange materials. At least one of the layers of ion exchange material comprises a mixture of ion exchange materials. The ion exchange material may include at least one ionomer. The at least one ionomer may include a proton conducting polymer. The proton conducting polymer may include perfluorosulfonic acid.

In some embodiments, the microporous polymer structure has a first surface and a second surface. The ion exchange material may form a layer on the first surface, on the second surface, or both on the first surface and the second surface. According to various embodiments, the ion exchange material may be partially embedded within the microporous polymer structure leaving a non-occlusive portion of the microporous polymer structure closest to the first surface, second surface or both. The non-occlusive portion may be free of any of the ion exchange material. The non-occlusive portion may include a coating of ion exchange material to an internal surface of the microporous polymer structure.

The polymer electrolyte membrane may comprise a single porous layer. The composite electrolyte membrane may comprise more than one porous layer. In embodiments in which the composite electrolyte membrane comprises at least two porous layers, the composition of at least two porous layers may be the same, or it may be different.

The microporous polymer structure of the porous layer may comprise a fluorinated polymer. The fluorinated polymer may be selected from the group comprising: polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof. The fluorinated polymer may be perfluorinated expanded polytetrafluoroethylene (ePTFE).

The polymer electrolyte membrane may include at least one backing layer attached to one or more external surfaces of the membrane. In some embodiments, the polymer electrolyte membrane may be released (or otherwise uncoupled) from the backing layer prior to being incorporated in a membrane electrode assembly (MEA).

Suitable backing layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the backing layer may include, for example, a spun-bonded polypropylene from Reemay Inc. of Old Hickory, Tenn. In other aspects, the backing layer can include web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). In some aspects, the backing layer also includes a protective layer, which can include polyethylene (PE), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). In yet other aspects, backing layer optionally may include a reflective layer that includes a metal substrate (e.g., an aluminum substrate).

Preferably, the backing layer comprises a polymer sheet substrate (obtained from DAICEL VALUE COATING LTD., Japan) comprising PET and a protective layer of cyclic olefin copolymer (COC), and during the process, the backing layer is oriented with the COC side on top.

As used herein, the terms “ionomer”, proton-conducting polymer and “ion exchange material” refer to a cation exchange material, an anion exchange material, or an ion exchange material containing both cation and anion exchange capabilities. Mixtures of ion exchange materials may also be employed. Ion exchange material may be perfluorinated or hydrocarbon-based. Suitable ion exchange materials include, for example, perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. In exemplary embodiments, the ion exchange material comprises perfluorosulfonic acid (PFSA) polymers made by copolymerization of tetrafluoroethylene and perfluorosulfonyl vinyl ester with conversion into proton form.

As used herein, the term “coating composition” refers to liquid solutions or dispersions forming an electrode. The desired coating material is typically dissolved or suspended into a precursor solution or slurry (also referred as “ink”) and delivered onto the surface of the substrate through a precise coating head known as injection nozzle or a slot-die. The coating composition may form an anode or a cathode or both. The coating composition may be same or different for forming the anode or the cathode.

In one embodiment, the coating composition comprises a catalyst ink solution. Upon drying the composite, the solvent of the catalyst ink may dry to form a solid electrode layer.

In another embodiment, the coating composition comprises a catalyst and an ionomer.

The catalyst comprises a noble metal, a transition metal, or an alloy thereof, and may be supported (optionally on a carbon support) or unsupported.

In another embodiment, the ionomer is a proton-conducting polymer.

In another embodiment, the proton-conducting polymer comprises perfluorosulfonic acid.

In another embodiment, the coating composition comprising a solution or dispersion of an aqueous mixture.

The aqueous mixture may comprise water, a water-soluble compound, a catalyst and an ionomer.

The aqueous mixture optionally further comprises a water-soluble compound, optionally a water-soluble alcohol. Where the water-soluble compound comprises a water-soluble alcohol, the water-soluble alcohol optionally comprises isopropanol, tert-butanol or a glycol ether. If included in the mixture, the glycol ether optionally comprises dipropylene glycol (DPG) or propylene glycol methyl ether (PGME). The optional water-soluble compound may be present in the aqueous mixture in an amount less than 50 wt. %, optionally in an amount less than 25 wt. %, optionally in an amount less than 9 wt. %, or optionally in an amount less than 4 wt. %, based on a total weight of the ionomer and vehicle in the aqueous mixture. According to various embodiments, the aqueous mixture may contain organic compounds.

In another embodiment the aqueous mixture comprising water, a water-insoluble component, a catalyst, and an ionomer, wherein the water-insoluble component comprises a water-insoluble alcohol, water-insoluble carboxylic acid or a combination thereof. In some embodiments, the water-insoluble component comprises a C5-C10 alcohol, a C5-C10 carboxylic acid, or a combination thereof.

In another embodiment, the coating composition comprises an ink solution comprising at least 1% wt solids for forming the cathode. In another embodiment, the coating composition comprises an ink solution comprising at least 2% wt solids for forming the cathode. In another embodiment, the coating composition comprises an ink solution comprising at least 3% wt solids for forming the cathode. In another embodiment, the coating composition comprises an ink solution comprising at least 4% wt solids for forming the cathode. In another embodiment, the coating composition comprises an ink solution comprising at least 5% wt solids for forming the cathode. In another embodiment, the coating composition comprises an ink solution comprising at least 6% wt solids for forming the cathode. In another embodiment, the coating composition comprises an ink solution comprising at least 7% wt solids for forming the cathode. In another embodiment, the coating composition comprises an ink solution comprising at least 8% wt solids for forming the cathode. In another embodiment, the coating composition comprises an ink solution comprising at least 9% wt solids for forming the cathode. In another embodiment, the coating composition comprises an ink solution comprising at least 10% wt solids for forming the cathode.

In another embodiment, the coating composition comprising an ink solution or dispersion comprising at least 10 wt % of catalyst and ionomer for forming the cathode.

The wt % of the above statements is based on 50% Pt/C ration. The skilled person will adjust the wt % if another Pt/C ration is chosen.

In another embodiment, the coating composition comprises an ink solution comprising at least 1% wt solids for forming the anode. In another embodiment, the coating composition comprises an ink solution comprising at least 2% wt solids for forming the anode. In another embodiment, the coating composition comprises an ink solution comprising at least 3% wt solids for forming the anode. In another embodiment, the coating composition comprises an ink solution comprising at least 4% wt solids for forming the anode. In another embodiment, the coating composition comprises an ink solution comprising at least 5% wt solids for forming the anode. In another embodiment, the coating composition comprises an ink solution comprising at least 6% wt solids for forming the anode. In another embodiment, the coating composition comprises an ink solution comprising at least 7% wt solids for forming the anode. In another embodiment, the coating composition comprises an ink solution comprising at least 8% wt solids for forming the anode. In another embodiment, the coating composition comprises an ink solution comprising at least 9% wt solids for forming the anode. In another embodiment, the coating composition comprises an ink solution comprising at least 10% wt solids for forming the anode.

In another embodiment, the coating composition comprising a solution comprising at least 10 wt % of catalyst and ionomer for forming the anode.

The wt % of the above statements is based on 50% Pt/C ration. The skilled person will adjust the wt % if another Pt/C ration is chosen.

The method of this disclosure controls the catalyst ink pump flow and the vertical movement of the slot die over the PEM substrate so as to break the catalyst ink flow cleanly, thus creating good edge quality whilst not wasting any catalyst ink.

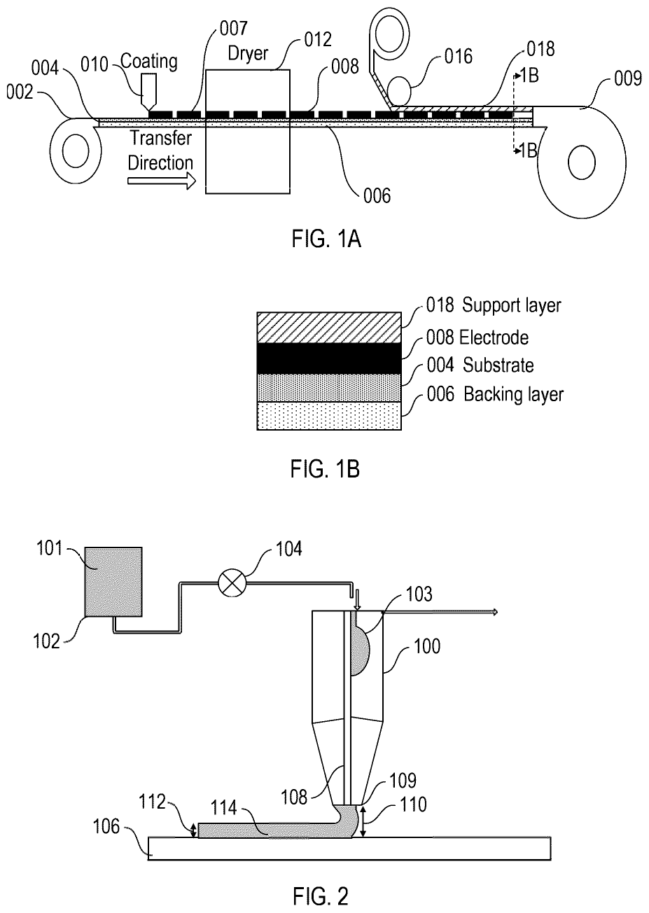

FIG. 1A shows an exemplary intermittent coating process. FIG. 1B shows a cross section of the composite, along the line AA in FIG. 1A.

In FIG. 1A, a reel 002 is shown, wherein the 002 reel comprises a substrate 004 roll with a backing layer 006. The rolled substrate 004 including the backing layer 006 on the reel 002 is continuously unwound to reveal the substrate 004 with the backing layer 006. The substrate 004 with the backing layer 006 is moving from the reel 002 in horizontal direction to a reel 009 passing an apparatus with coating means 010 like a slot die for depositing a coating composition 007. In one embodiment the movement of the substrate 004 might be supported by a moving table or belt drive (not shown). In the embodiment of FIG. 1A the backing layer 006 is facing the table surface (not shown) and a first surface of the substrate 004 facing the opposite.

The first surface of the substrate 004 is then coated with a first coating composition 007 forming the first electrode 008 via coating means 010. The coating means 010 may be a slot die. The slot die may be stationary or movable in relation to the moving substrate 004. FIG. 1A shows the coating composition 007 has been applied in an intermittent manner forming a discontinuous pattern. The substrate 004 and the newly formed wet first electrode then pass through a dryer 012 where the wet first electrode is dried and set for forming first electrode 008.

Following the drying step, a support layer 018 may be applied on to the dried first electrode 008. The support layer 018 may be applied using conventional apparatus 016. The apparatus 016 delivers a continuous roll of the support layer 018, which is applied on to the dried first electrode 008. In one embodiment the support layer 018 is applied by a lamination process using a hot roll and pressure. This forms a composite comprising at this stage in the process, the backing layer 006, the substrate 004, the first electrode 008, and the support layer 018. The composite is then moved towards and held on the second reel 009.

FIG. 1B shows the composite and the order of the layers, starting from the inside of the reel 009 and extending outwards (in a radial direction) are 1) the backing layer 006, 2) the substrate 004, 3) the first electrode 008, and 4) the support layer 018.

The intermittent direct coating method according to this disclosure might be repeated on the uncoated surface of the substrate after the backing layer 006 has been taking off.

Considering FIG. 2, there is an exemplary process and apparatus for intermittent direct coating on a substrate 106 shown. A slot die 100 is used to distribute the catalyst ink solution 101 from the catalyst ink solution reservoir 102 onto the surface of the substrate 106. The substrate 106 is arranged horizontally and may move horizontally. The apparatus also comprises a catalyst ink solution pump 104 which can control the flowrate of the catalyst ink solution 101. The catalyst ink solution 101 passes from the catalyst ink solution reservoir 102 to the slot die 100, via the catalyst ink solution pump 104, where it then typically passes into a slot die reservoir 103, before being delivered out of a slot die head 109 and onto the substrate 106 in form of a catalyst ink film 114.

The flow rate of the catalyst ink solution 101 and the coating speed of the apparatus are in relation to each other. The coating speed may be defined by the horizontal moving speed of the substrate 106 or the speed of the slot die moving horizontally over the substrate 106.

In one embodiment the flowrate of the catalyst ink solution pump 104, which feeds the slot die 100, may be around 0.75 ml/min by a coating speed of about 1 m/min. In another embodiment the flowrate of the catalyst ink solution pump 104 may be around 9.5 ml/min by a coating speed of around 10 m/min.

Another feature of the slot die 100 is a shim or shim masks 108. Shims 108 are used to adjust the channel width in the slot die 100 and may provide the coating pattern of the catalyst ink film 114 depending on the shim mask design. Shim 108 thicknesses can be adjusted to suit different types of ink solution, which may vary in viscosity and density. The shims 108 provide an easy way to adjust and vary the thickness of the channel in the slot die 100. In an embodiment the shim thickness may be around 150 μm.

For example, catalyst ink solutions with higher viscosities may need thicker channels in the slot die 100 than catalyst ink solutions with lower viscosity. Catalyst ink solutions with higher viscosities would therefore require thicker shims 108 to be inserted into the slot die 100.

The slot die 100 may be adjusted to suit different coating applications, by moving the slot die 100 in a vertical direction closer or further away from the substrate 106. In particular, the slot die 100 may be movable in a vertical direction relative to the substrate 106. The vertical movement of the slot die 100 positions the slot die in different distances relative to the substrate 106. In one embodiment the slot die 100 is in a first pre-defined distance relative to the substrate and in a second pre-defined distance relative to the substrate.

In the first pre-defined distance the slot die 100 is further away from the substrate 106 than in the second pre-defined distance. Or in the second pre-defined distance the slot die 100 is arranged closer to the substrate 106 than in the first pre-defined distance.

In one embodiment the first pre-defined distance corresponds with the non-coating position of the slot die 100 and the second pre-defined distance corresponds with the coating position of the slot die 100.

According to FIG. 2, the slot die 100 is in the coating position.

When the slot die 100 is in the coating position, the distance of the slot die head 109 closest to the surface of the substrate 106 is known as the slot die gap 110. The slot die gap 110 is an important variable in controlling the quality of the catalyst ink film 114 being deposited. The slot die gap 110 is defined relative to when the slot die 100 is in the coating position.

The slot die gap 110 between the slot die head 109 and the substrate 106 can be described in relation to the wet thickness 112 of the catalyst ink film 114. In one embodiment, the ratio of slot die gap 110 to catalyst ink film thickness 112 may be 1.25. In other embodiments the ratio of slot die gap 110 to catalyst ink film thickness 112 may be between 1.0 to 2.0.

In another embodiment, the slot die gap 110 can be around 1.25 times the catalyst ink film thickness 112.

In some embodiments, the wet thickness 112 of the catalyst ink film 114 may be between 70 μm to 90 μm. In one embodiment the wet thickness of the catalyst ink film is about 75 μm or 80 μm. Thus, if the wet thickness 112 of the catalyst ink film 114 is 80 μm, then the slot die gap 110 would be 100 μm. The slot die gap 110 may be adjusted throughout the coating process to suit changing material parameters.

In one embodiment the substrate 106 comprises a polymer electrolyte membrane (PEM). A PEM as substrate may have a thickness of between 5 to 50 μm, preferably between 10 to 45 μm; between 15 to 40 μm, between 20 to 35 μm, between 25 to 30 μm. In one embodiment, the catalyst ink comprises a dispersion of ionomer, catalyst and carbon mixed in a solvent. In one embodiment the dispersion comprises around 6 volume % solids (ionomer, catalyst, carbon) and has a viscosity of around 180 mPas (at 100 s⁻¹ shear rate).

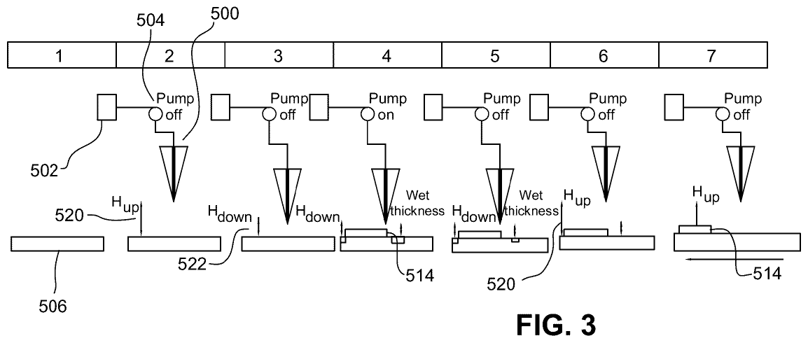

FIG. 3 shows a process diagram of an intermittent coating method according to the disclosure.

FIG. 3 shows illustrative process steps 1-7 according to the present disclosure. The process steps are labelled 1-7 above each image.

Step 1 involves preparing the catalyst ink, and providing the substrate 506. During the process steps 1-7 the substrate 506 is moving in a horizontal direction from right to the left as indicated by the arrow shown in step 7.

Step 2 shows the ink reservoir 502, along with the pump 504, both of which are connected to the slot die 500. As shown in step 2, the slot die 500 is in the non-coating position 520. The non-coating position is an elevated position or first pre-determined distance Hup above the substrate 506, and the slot die 500 does not inject or deposit from this height. In step 2, the catalyst ink is added to the slot die reservoir (not shown), and the intermittent coating parameters are set. The pump 504 is in the pump OFF setting.

In step 3, the slot die 500 moves down into the coating position 522, i.e. where the slot die 500 is closer to the substrate 506 in the second pre-determined distance Hdown 522, and is ready to deposit the catalyst ink. The second pre-determined distance Hdown 522 corresponds to the slot die gap as explained in FIG. 2.

In step 4, the pump 504 is switched into the pump ON setting, which starts the coating process. Depending on the coating speed and the pumping rate a catalyst ink film 514 having a specific wet thickness is coated on the surface of the substrate 506. An example of an ink deposit is shown.

In step 5, and after the catalyst ink film 514 has been deposited (as shown by the ink deposit 514), the pump 504 is switched to the pump OFF setting. Following this, in step 6, the slot die 500 moves up into the non-coating Hup position 520.

In step 7, the coated substrate 506 continues moving further for a pre-determined horizontal distance before steps 3-7 are repeated until required.

The process according to this disclosure also includes a drying step after the coating step.

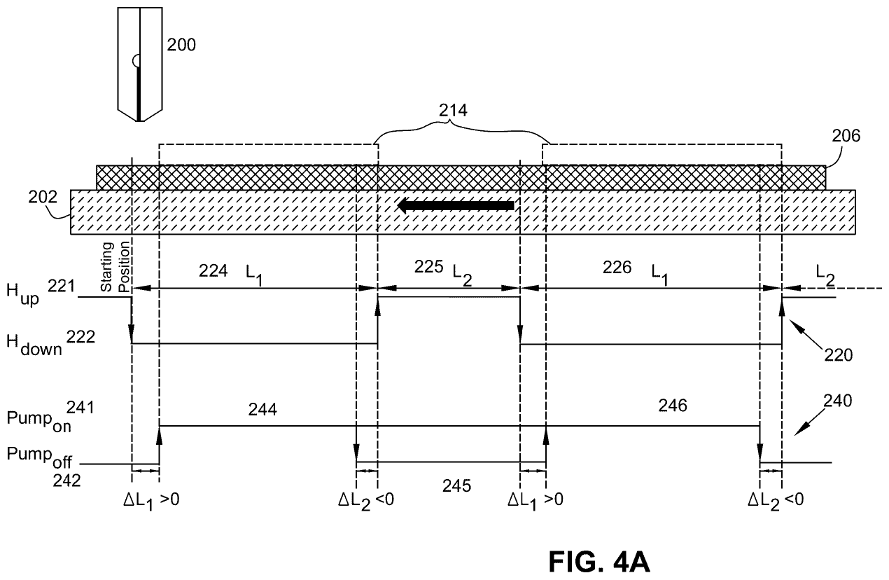

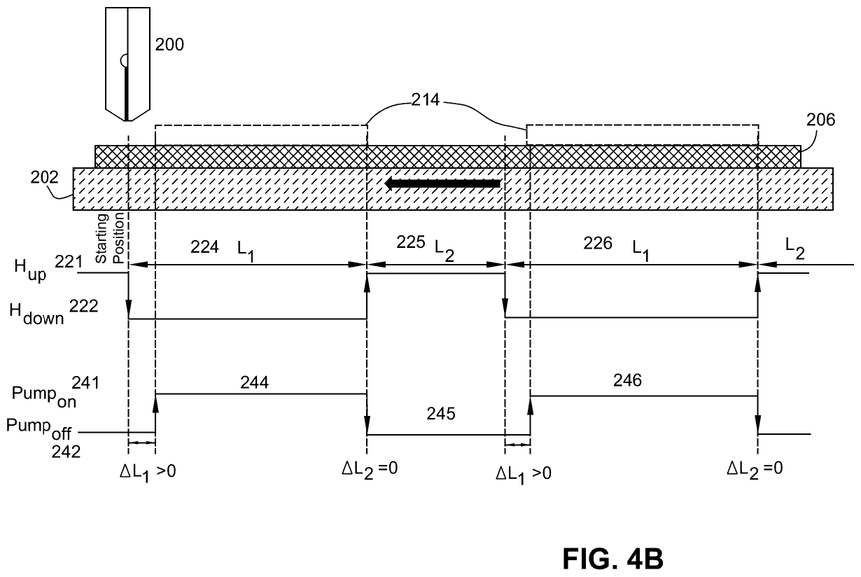

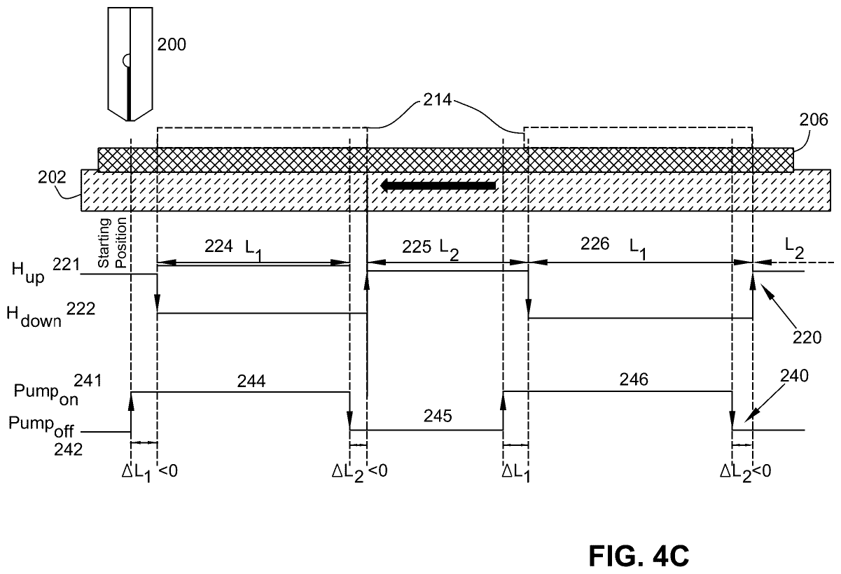

FIGS. 4A-4C show examples of process diagrams of the method according to the disclosure. FIGS. 4A-4C showing in more details how the slot die and the pump according to this disclosure are working together for the delivery of an intermittent catalyst coating pattern with clean trailing edges of the electrodes.

In FIG. 4A, a slot die 200 is shown in the top left of the Figure. A movable table or belt drive 202 is shown, and a substrate 206 which is located on top of table 202. The substrate 206 is moving from the right to the left as indicated by the arrow. Two intermittent catalyst ink deposits 214 are shown in dotted lines on top of the substrate 206, one next to the other with a horizontal distance in-between. The intermittent catalyst ink deposits 214 are going to be formed as result of the coating process further described below. The slot die 200 moves along a vertical axis relative to the substrate 206. The relative movement is normally achieved by moving the substrate along a horizontal plane (via a moving table or belt drive for example), whilst maintaining the slot die 200 in a fixed horizontal plane (but movable in the vertical axis). In an alternative embodiment the relative movement may be achieved by the slot die 200 moving in a horizontal plane, whilst the substrate remains stationary. Again, the movement between the slot die 200 and the substrate 206 is relative, and so the substrate 206 may move in the horizontal plane, without the slot die 200 moving in the horizontal plane.

In the lower portion of FIG. 4A, a middle ‘status’ graph 220 is shown, where the graph 220 represents the position of the slot die 200, whether it is in the coating position (Hdown) 222 or in the non-coating position (Hup) 221 (i.e. the status of the slot die 200). The graph shows what position the slot die 200 is in, relative to the substrate 206.

The non-coating position Hup is at a first pre-determined vertical distance relative to the substrate 206 and defines a first height of the slot die 200 relative to the substrate 206 in which the slot die 200 is located further away from the substrate 206 and will be interchangeably referred to herein as a Hup position 221 of the slot die 200. The coating position is a second pre-determined vertical distance relative to the substrate 206 and defines a second height of the slot die 200 relative to the substrate 206 in which the slot die 206 is located closest to the substrate 206 and will be interchangeably referred to herein as a Hdown position 222 of the slot die 200.

A bottom ‘status’ graph 240, below the graph 220 indicating the height of the slot die 200, illustrates when the pump (not shown) may be described as pump-ON state 241 or pump-OFF state 242. The pump can be intermittently cycled between these two modes, to accurately control the amount of and timing of the ink deposits.

As the substrate 206 moves from right to left in this illustrative example, the slot die 200 can move vertically between the coating position 222 and the non-coating position 221 relative to the substrate 206, and the pump can be in a pump-ON state 241 or a pump-OFF state 242. The apparatus is designed to control these variables in such a manner as to produce high quality ink deposits, which have good trailing edge characteristics. A combination of vertically moving the slot die 200 to the non-coating position 221 and turning the pump to pump OFF state 242 can create a sharp trailing edge on the ink deposits 214.

In the embodiment of FIG. 4A a top status graph illustrates the timings of the vertical movement of the slot die 200 relative to the substrate 206. In the example of FIG. 4A L1 represents the time or horizontal distance of the coating position Hdown 222 of the slot die 200 and L2 represents the time or horizontal distance of the non-coating position Hup 221 of the slot die 200. In this example, the coating process of the catalytic ink deposit 214 starts when the slot die 200 is moved down from Hup 221 to Hdown 222 into the first coating condition 224 at a second predetermined distance (starting position). Now considering the bottom status graph 240, soon after the slot die 200 moves into the coating position Hdown 222, the pump changes from pump OFF state 242 to pump ON state 241 to be in the first pump ON condition 244. The distance or time between when the slot die 200 moves into the first coating condition 224, and when the pump changes to the pump ON condition 244, may be defined as delta L₁. In this specific example, delta L₁ is a positive value, i.e. greater than zero.

This then starts the process of catalytic ink flowing from the slot die 200. After a predetermined time or horizontal distance in the first pump ON condition 244, the pump changes to first pump OFF condition 245, before the slot die 200 moves up into the first non-coating condition 225. The pump is now in the pump OFF state 242, and the slot die 200 is in the non-coating position Hup 221. The distance or time between when the pump changes into the pump OFF state 242, and when the slot die moves into the non-coating position Hup 221, may be defined as delta L₂. In this specific example, delta L₂ has a negative value, i.e. less than zero.

As substrate 206 moves in the horizontal plane the process is repeated. Again, the slot die 200 moves closer to the substrate 206, into the coating position Hdown 222. The slot die 200 is now in the second coating condition 226. Again, after a predetermined distance/time, the pump switches from the pump OFF state 242 to the pump ON state 241, into the second pump ON condition 246. The slot die 200 then starts to deposit ink. Once again, the distance or time between when the slot die 200 moves into the second coating condition 226, and when the pump changes to the pump ON condition 246, may be defined as delta L₁. After a predetermined time or distance, the pump then switches to the pump OFF state 242, and shortly after, the slot die 200 is raised to the non-coating position Hup 221. As before, the distance or time between when the pump changes into the pump OFF state 242, and when the slot die moves into the non-coating position Hup 221, may be defined as delta L₂.

It is through these sequence of events that the quality of the trailing edge of the ink deposits 214 can be controlled. The times between lowering the slot die 200 and starting the pump, stopping the pump and raising the slot die 200 can be varied according to the particular application. In particular, the vertical movement of the slot die 200 from Hdown to Hup in connection with the pump off conditions using the delta L1 and delta L2 parameters leads to clean sheared edges or significant minimized edge trails.

The status graphs in FIG. 4A also show the slot die 200 being lowered into the coating position Hdown 222 before the pump is switched into pump ON state 241. This is not necessarily the order of events, and in some circumstances, the apparatus may switch the pump to pump ON state 241, before the slot die 200 is lowered into the coating position Hdown 222 for example. Some examples of varying embodiments of operating the method of the disclosure will be described below.

FIG. 4B shows a similar process diagram to that which is in FIG. 4A, however in this example, delta L₁ is a positive value (greater than zero), and delta L₂ is zero. This means in practice, that the method is the same as described in 4A, however after the coating has taken place, the slot die 200 moves into the first non-coating condition 225 (i.e. the Hup position 221) simultaneously with the pump changing to the pump OFF condition 245 (i.e. pump OFF state 242). This is one of the configurations of the method according to the present disclosure.

FIG. 4C shows a similar process diagram to that which is in FIGS. 4A and 4B, however in this example delta L₁ is a negative value (less than zero), and delta L₂ is a negative value (less than zero). This means in practice, that the method is the same as described in 4A, however the pump is switched into the pump ON state 241 before the slot die 200 is moved into the coating position Hdown 222. This means the first pump ON condition 244 is reached prior to the slot die 200 moving into the first coating position 224. This is one of the configurations of the method according to the present disclosure.

Furthermore, instead of using predetermined horizontal distances, the apparatus may use predetermined time intervals for L1 and L2. These time intervals can be correlated with the coating speed of the slot die 200. The coating speed is the speed at which the substrate moves in the horizontal plane relative to the slot die 200. The substrate 206 may move, or the slot die 200 may move, providing there is relative movement between the two features.

An example will now be described, with reference to the intermittent coating process as described in FIGS. 4A to 4C.

A conventional polymer electrolyte membrane (PEM) with a thickness of 18 microns as substrate 206 has been provided. The substrate 206 is on a horizontal moving table 202. A single layer slot die commercially available from the company TSE Troller AG with a maximum coating width of 125 mm was used. The slot die was in use with a shim of 150 μm and a coating width of 54 mm. The slot die 200 is in liquid connection with a pump, commercially available as a syringe pump series from the company KDS Legato.

A catalyst ink solution with an ink solid content of 4.9 Vol % was used, which achieves a 0.4 mg/cm² platinum loading of the coated electrode patches 214 when the process is complete (i.e. after the drying step). The calculated flowrate of the catalyst ink is 5.4 cm³/min. The coating speed is about 1 m/min. The catalyst coating wet thickness is 100 μm.

The horizontal coating distance or length L1 (which is equivalent to the length of the first coating condition 224) is 100 mm, and the minimum horizontal coating distance or length L1min is 10 mm.

The distance between the electrode patches (catalyst ink deposits 214) is 50 mm, which is the equivalent to the length of the first non-coating condition 225. The minimum horizontal distance or length between these electrode patches is 10 mm.

The maximum distance delta L1max between the slot die 200 moving into the coating position Hdown 222 and when the pump switches into the pump ON state 241, is 50 mm (or 6 seconds, using time). If the coating distance or length L1 is 100 mm, then the maximum distance of delta L1 is 50 mm. Maximum distance delta L1 is related to L1 as explained herein.

The minimum distance delta L1min between the slot die 200 moving into the coating position Hdown 222 and when the pump switches into the pump ON state 241, is −50 mm (or −3 seconds, using time). The negative numbers indicate that the pump switches into the pump ON state 241 before the slot die 200 moves into the coating position Hdown 222 according to FIG. 4C. Depending on the material properties of the ink, and the slot die 200 setup, it may be necessary to turn the pump on, before moving the slot die into the coating position.

The maximum distance delta L2max between the slot die 200 moving into the non-coating position Hup 221 and when the pump switches to the pump OFF state 242, is 0 mm (or 0 seconds) according to FIG. 4B.

The minimum distance delta L2min between the slot die 200 moving into the non-coating position Hup 221 and when the pump switches to the pump OFF state 242, is −25 mm (or −1.5 s) according to FIGS. 4A and 4C.

The flowrate is a function of the coating speed, the coating wet thickness, and the coating width.

Example equations for calculating the maximum and minimum distances are as follows: For calculating the maximum and minimum horizontal distances delta L1max and delta L1min between the slot die 200 moving into the coating position Hdown 222 and when the pump switches into the pump ON state 241, the horizontal distance L1 when the slot die is in the coating position Hdown 222 (see first coating position 224 in FIG. 4A) is multiplied by 0.5.

The maximum horizontal distance delta L2max between the slot die 200 moving into the non-coating position Hup 221 and when the pump switches into the pump OFF state 242 is 0 mm. For calculating the minimum relative horizontal distance delta L2min between the slot die 200 moving into the non-coating position Hup 220 and when the pump switches into the pump OFF state 242, the horizontal distance when the slot die is in the non-coating position Hup 220 (see first non-coating position 225 in FIG. 4A) is multiplied by 0.5.

The distance the slot die 200 is in the non-coating configuration 220, can be at least 5% of the distance the slot die 200 is in the coating configuration 222 but at least 1 cm.

The above example is just one illustration of how the apparatus can be configured. The skilled person would easily understand that the parameters may be varied in accordance with the disclosure. These parameters may be varied to minimize the trailing edge trail, by shearing the ink with the slot die movement and changing the pump to the pump off setting.

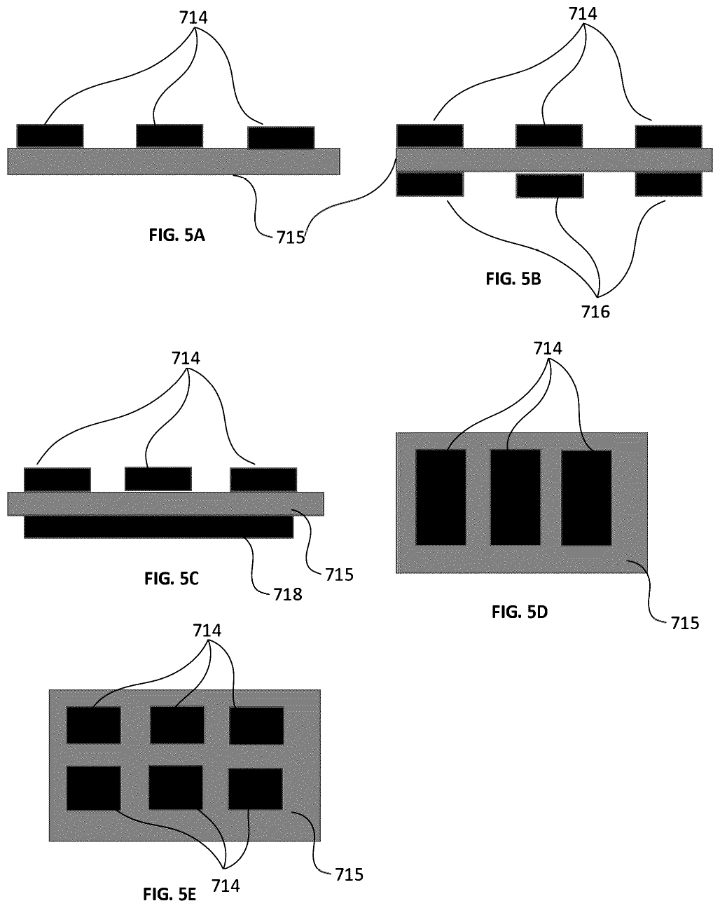

FIGS. 5A to 5E show several embodiments of products made with a method according to the disclosure. Catalytic ink deposits 714 are shown as being laid out on the substrates 715 in various different patterns.

FIG. 5A shows a schematic cross section of a product according to this disclosure with a substrate 715 e.g., a polymer electrolyte membrane and an intermittent coating 714 on one surface of the substrate 715 forming for example a cathode.

In FIG. 5B, the example in FIG. 5A is shown with an additional intermittent coating 716 on the opposite surface of the substrate 715, forming for example an anode. The example of FIG. 5B may present a MEA with intermittently coated electrodes 714, 716 on both sides of the polymer electrolyte membrane (PEM).

In FIG. 5C, the example in FIG. 5A is shown with an additional continuous coating 718 on the opposite surface of the substrate 715, forming for example an anode.

Two possible examples of ink deposit 714 widths are shown in the plan views of FIGS. 5D and 5E. FIG. 5D shows individual ink deposits 714 which almost extends to longitudinal edges of the substrate 715, whilst FIG. 5E shows six individual ink deposits 714. The width of the deposits may be determined by the width of the shim mask width. For example, for the ink deposit 714 layouts in FIG. 5E, there may only be a series of three intermittent coating steps, a shim may be used to separate each ink deposit into two separate deposits, thus creating six distinct ink deposits 714.

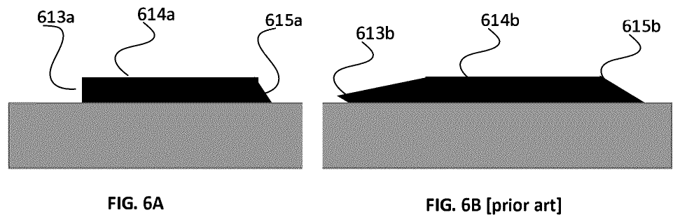

FIGS. 6A and 6B [prior art] show examples of good quality edges on an ink deposit 614a and poor-quality edges on an ink deposit 614b respectively. FIG. 6A shows a typical example of the trailing edge 615a quality which can be expected from the present disclosure. By accurately controlling the pump switch (on/off), and the height of the slot die (coating/non-coating position), the trailing edge 615a can be very sharp and well defined. This in turn saves ink and produces high quality electrodes.

In contrast, FIG. 6B shows examples of a poor-quality leading edge 613b and poor-quality trailing edge 615b. These are typical edges from coating processes according to the art.

The following examples describe the disclosure in more details. The examples are using a conventional polymer electrolyte membrane (PEM) with a thickness of 18 microns as substrate. A single layer slot die, commercially available from the company TSE Troller AG with a maximum coating width of 125 mm was used. The slot die was in liquid connection with a pump, commercially available as a syringe pump 200 series from the company KDS Legato. The intermittent coating process was carried out according to this disclosure.

Example 1: A single layer slot die as described above was used with a shim of 175 μm and a coating width of 54 mm. The slot die was in liquid connection with a pump as described above having a pump flowrate of 4.46 ml/min. The catalyst ink solution has an ink solid content of 4.8 Vol %, which achieves a 0.54 mg/cm² platinum loading of the electrode patches when the process is complete (i.e. after the drying step).

The catalyst ink solution comprises the following parameters: viscosity of 170 mPas at 100s−1 shear rate, Median particle size D50 (μm): 0.265 μm.

A commercially available polymer electrolyte membrane with a thickness of 18 μm provided with a backing layer was directly coated with the described above catalytic ink solution according to the method of this disclosure. The wet thickness of the coating was 82.62 μm. The gap to thickness ratio was 1.25, giving a gap height of 171 μm. The coating speed was 1 m/min. The pump turned on 15 mm (negative delta L1) before the slot die was lowered into the coating position Hdown. The slot die was in the coating position for 100 mm (L1). The slot die was raised from the coating position at the same time as the pump was turned off. The slot die remained raised for 50 mm (L2), before the process was repeated. The ink was then dried. This process resulted in a platinum loading of 0.54 mg/cm². The coated electrode patches having clean high quality edges as shown exemplary in FIG. 6A.

Example 2: A single layer slot die as described above was used with a shim of 150 μm and a coating width of 54 mm.

The slot die was in liquid connection with a pump as described above having a pump flowrate of 4.91 ml/min. The catalyst ink solution has an ink solid content of 4.8 Vol %, which achieves a 0.40 mg/cm² platinum loading of the electrode patches when the process is complete (i.e. after the drying step). The catalyst ink solution comprises the following parameters: viscosity of 140 mPas at 100 s⁻¹ shear rate, Median particle size D50 (μm): 0.289 μm.

A commercially available polymer electrolyte membrane with a thickness of 18 μm provided with a backing layer was directly coated with the described above catalytic ink solution according to the method of this disclosure.

The wet thickness of the coating was 91 μm. The gap to thickness ratio was 1.25, giving a gap height of 182 μm. The coating speed was 1 m/min. The pump turned on 10 mm (delta L1) before the slot die was lowered into the coating position. The slot die was in the coating position for 60 mm (L1). The slot die was raised from the coating position 15 mm before the pump was turned off (delta L2). The slot die remained raised for 78 mm (L2), before the process was repeated. The ink was then dried. This process resulted in a platinum loading of 0.40 mg/cm². The electrode patches having clean high quality edges as shown exemplary in FIG. 6A.

Example 3: A single layer slot die as described above was used with a shim of 100 μm and a coating width of 54 mm.

The slot die was in liquid connection with a pump as described above having a pump flowrate of 0.945 ml/min. The catalyst ink solution has an ink solid content of 6 Vol %, which achieves a 0.096 mg/cm² platinum loading of the electrode patches when the process is complete (i.e. after the drying step). The catalyst ink solution comprises the following parameters: viscosity of 71 mPas at 100 s−1 shear rate, Median particle size D50 (μm): 0.223.

A commercially available polymer electrolyte membrane with a thickness of 18 μm provided with a backing layer was directly coated with the described above catalytic ink solution according to the method of this disclosure.

The wet thickness of the coating was 17.5 μm. The gap to thickness ratio was 1.25, giving a gap height of 90 μm. The coating speed was 1 m/min. The pump turned on 20 mm before the slot die was lowered into the coating position (delta L1). The slot die was in the coating position for 55 mm (L1). The slot die was raised at the same time the pump was turned off (delta L2). The slot die remained raised for 30 mm (L2) before the process was repeated. The ink was then dried. This process resulted in a platinum loading of 0.096 mg/cm².

While the invention has been described in detail, modifications within the spirit and scope of the invention will be readily apparent to the skilled artisan. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by the skilled artisan. Furthermore, the skilled artisan will appreciate that the foregoing description is by way of example only, and is not intended to limit the invention.

1. A method of making a fuel cell component, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; wherein the forming further comprises
(vi) configuring the slot die for predetermined intermittent delivery of the coating composition to produce an electrode on the substrate when the slot die is in the coating position.

2. The method of claim 1, wherein the method comprises the step of providing a pump in fluid communication with the slot die for controlled intermittent delivery of the coating composition from the slot die to the substrate, the pump being adapted to be turned off by putting the pump into an OFF condition and the pump being adapted to be turned on by putting the pump into an ON condition.

3. The method of claim 1, wherein the method further comprises moving the slot die between the non-coating position and the coating position in a controlled, pre-determined manner to deliver the coating composition to the substrate in a pre-determined pattern of delivery, wherein
in the non-coating position, the slot die is located at a first pre-determined distance relative to the substrate; and
in the coating position, the slot die is located at a second pre-determined distance relative to the substrate; wherein
in the first pre-determined distance, the slot die is located further away from the substrate than in the second pre-determined distance.

4. The method of claim 3, wherein the first pre-determined distance defines a Hup position of the slot die and the second pre-determined distance defines a Hdown position of the slot die.

5. The method of claim 2, wherein the pump is changed from the OFF condition to the ON condition, before or after the slot die is moved from the non-coating position to the coating position.

6. The method of claim 2, wherein the pump is changed from the ON condition to the OFF condition, before or at the same time the slot die is moved from the coating position to the non-coating position.

7. The method of claim 5, when the pump is changed from the OFF condition to the ON condition after the slot die is moved from the non-coating position to the coating position, wherein the distance (delta L1) the substrate moves in a horizontal direction when the slot die is in the coating position with the pump in the OFF condition, is up to 50% of the distance (L1) the substrate moves in the horizontal direction when the slot die is in the coating position.

8. The method of claim 5, when the pump is changed from the OFF condition to the ON condition before the slot die is moved from the non-coating position to the coating position, wherein the distance (delta L1) the substrate moves in a horizontal direction when the slot die is in the non-coating position with the pump in the ON condition, is up to 50% of the distance (L1) the substrate moves in the horizontal direction when the slot die is in the coating position.

9. The method of claim 6, when the pump is changed from the ON condition to the OFF condition before the slot die is moved from the coating position to the non-coating position, wherein the distance (delta L2) the substrate moves in a horizontal direction when the slot die is in the coating position with the pump in the OFF condition, is up to 50% of the distance the substrate moves in the horizontal direction when the slot die is in the coating position (L1).

10. The method of claim 1, wherein the method comprises the step of providing a controller programmed with pre-determined parameters for controlling the intermittent delivery of the coating composition from the slot die to the substrate.

11. The method of claim 2, wherein the method comprises the step of controlling the intermittent delivery of the coating composition from the slot die using pre-determined vertical movement of the slot die and the turning the pump to the OFF and ON conditions.

12. The method of claim 1, wherein the substrate comprises a polymer electrolyte membrane (PEM).

13. The method of claim 1, wherein the fuel cell component is a membrane electrode assembly (MEA).

14. The method of claim 1, wherein the fuel cell component is a catalyst coated membrane (CCM).

15. The method of claim 1, wherein the coating composition comprises a catalyst and an ionomer.

16. The method of claim 15, wherein the catalyst comprises a noble metal, a transition metal, or an alloy thereof.

17. The method of claim 1, wherein the electrode is a cathode or an anode.

18. The method of claim 1, wherein the coating composition comprising a solution comprising at least 5% wt solids for forming the cathode.

19. The method of claim 1, wherein the coating composition comprising a solution comprising at least 5% wt solids for forming the anode.

20. The method of claim 1, wherein the first and the second pre-determined distance relative to the substrate is provided by a vertical movement of the slot die.

21. The method of claim 1, wherein a gap to thickness ratio is used to determine the coating position of the slot die wherein the thickness is defined as the thickness of the deposited coating composition.

22. A method of making a fuel cell component, the method comprising:
forming an electrode on a polymer electrolyte membrane (PEM), wherein the forming comprises the following steps:
(i) providing a PEM substrate;
(ii) providing an electrode coating composition;
(iii) providing apparatus comprising a slot die configured for intermittent delivery of the electrode coating composition to the PEM substrate;
(iv) wherein the forming includes intermittently depositing the coating composition on the PEM substrate; and
(v) wherein the slot die is moveable between a non-coating position in which the slot die is in a first pre-determined distance relative to the PEM substrate; and a coating position in which the slot die is in a second pre-determined distance relative to the PEM substrate; wherein the forming further comprises
(vi) configuring the slot die for predetermined intermittent delivery of the coating composition to produce an electrode on the PEM substrate when the slot die is in the coating position.

23. A method of making a component of a water electrolysis device, the method comprising:
(i) providing a substrate;
(ii) providing a coating composition;
(iii) providing apparatus comprising a slot die configured for intermittent delivery of the coating composition to the substrate for forming an electrode on the substrate,
(iv) wherein the forming includes intermittently depositing the coating composition on the substrate; and
(v) wherein the slot die is moveable between a non-coating position in which the slot die is in a first pre-determined distance relative to the substrate; and a coating position in which the slot die is in a second pre-determined distance relative to the substrate; wherein the forming further comprises
(vi) configuring the slot die for predetermined intermittent delivery of the coating composition to produce an electrode on the substrate when the slot die is in the coating position.

24. The method of claim 23, wherein the substrate comprises a polymer electrolyte membrane (PEM).

25. The method of claim 23, wherein the component of the water electrolysis device is a membrane electrode assembly (MEA).

26. The method of claim 23, wherein the component of the water electrolysis device is a catalyst coated membrane (CCM).
